(19) United States
(12) Patent Application Publication
(10) Pub. No.: US 2025/0238941 A1
(43) Pub. Date: Jul. 24, 2025

(54) DRIVER CIRCUIT AND METHOD FOR DRIVING DISPLAY PANEL

(71) Applicant: Novatek Microelectronics Corp., Hsinchu (TW)

(72) Inventors: Tsu Cheng Li, Taichung City (TW); Yen-Tao Liao, Hsinchu City (TW); Hui-Feng Lin, Taichung City (TW)

(73) Assignee: Novatek Microelectronics Corp., Hsinchu (TW)

(21) Appl. No.: 18/418,319

(22) Filed: Jan. 21, 2024

(51) Int. Cl. G06T 7/40; G09G 3/20

(52) U.S. Cl. CPC G06T 7/40; G09G 3/20; G09G 2320/0626; G09G 2330/021

(57) ABSTRACT

A driver circuit configured to drive a display panel is provided. The driver circuit includes an image processing circuit. The image processing circuit is configured to receive and analyze an input image and adjust a brightness of the input image to generate an output image according to the at least one duty distribution. The image processing circuit determines the at least one duty distribution according to an analysis result of the input image. The input image includes a first area and a second area, and a brightness of the first area is adjusted to be different from a brightness of the second area.

### BACKGROUND

### Technical Field

The invention relates to an electronic circuit and a driving method, more specifically, to a driver circuit and a method for driving a display panel.

### Description of Related Art

The principle behind the emission of light in OLED displays is the combination of electric holes and charges in the light-emitting layer. This, in turn, excites the organic material to produce photons. It is important to note that the amount of light emitted is proportional to the power consumption, given the same display material. Therefore, to reduce power consumption in OLED displays, it is necessary to minimize the amount of light emitted. The general power-saving method is to dim the panel synchronously. Although this method can effectively save power, it may sacrifice certain image quality, such as color shift caused by brightness changes, low brightness details, and screen contrast, which can affect the user experience.

### SUMMARY

The invention is directed to a driver circuit and a method for driving a display panel, capable of reducing the power consumption of the display panel, and maintaining good image quality.

An embodiment of the invention provides a driver circuit configured to drive a display panel. The driver circuit includes an image processing circuit. The image processing circuit is configured to receive and analyze an input image and adjust a brightness of the input image to generate an output image according to the at least one duty distribution. The image processing circuit determines the at least one duty distribution according to an analysis result of the input image. The input image includes a first area and a second area, and a brightness of the first area is adjusted to be different from a brightness of the second area.

An embodiment of the invention provides a method for driving a display panel, and the method includes: receiving and analyzing an input image; determining at least one duty distribution according to an analysis result of the input mage; and adjusting a brightness of the input image to generate an output image according to the at least one duty distribution. The input image comprises a first area and a second area, and a brightness of the first area is adjusted to be different from a brightness of the second area.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram illustrating an electronic device according to an embodiment of the invention.

FIG. 2 is a schematic diagram illustrating a duty distribution of FIG. 1 according to an embodiment of the invention.

FIG. 3 is a schematic diagram illustrating average pixel levels of pixel block of an input image according to an embodiment of the invention.

FIG. 4 is a schematic diagram illustrating an input image according to an embodiment of the invention.

FIG. 5 is a schematic diagram illustrating an input image according to an embodiment of the invention.

FIG. 6 is a schematic diagram illustrating an input image and a weight matrix according to an embodiment of the invention.

FIG. 7 is a schematic diagram illustrating different scenario modes and corresponding duty distributions according to an embodiment of the invention.

FIG. 8 is a schematic diagram illustrating a brightness adjustment of an input image according to an embodiment of the invention.

FIG. 9 is a flowchart illustrating a method for driving a display panel according to an embodiment of the invention.

### DESCRIPTION OF THE EMBODIMENTS

Embodiments are provided below to describe the disclosure in detail, though the disclosure is not limited to the provided embodiments, and the provided embodiments could be suitably combined. The term “coupling/coupled” or “connecting/connected” used in this specification (including claims) of the application may refer to any direct or indirect connection means. For example, “a first device is coupled to a second device” should be interpreted as “the first device is directly connected to the second device” or “the first device is indirectly connected to the second device through other devices or connection means.” In addition, the term “signal” could refer to a current, a voltage, a charge, a temperature, data, electromagnetic wave or any one or multiple signals.

This disclosure aims to reduce the power consumption of the display panel while maintaining good image quality by reducing the amount of light emitted. Unlike a case that reduces the brightness of the whole image, the driver circuit may drive the center area and the outer area with different brightness adjustment, so that the image quality of the main visual area, e.g. the center area, can be maintained.

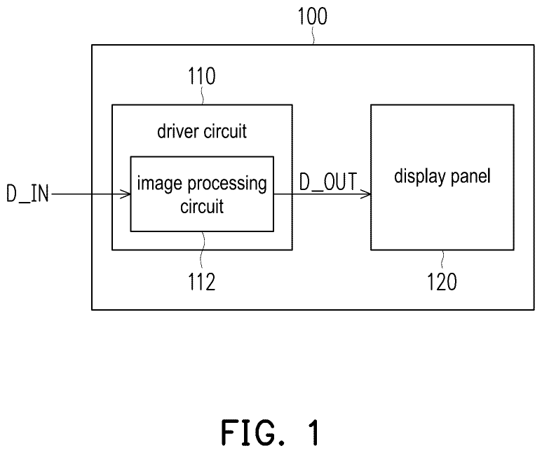

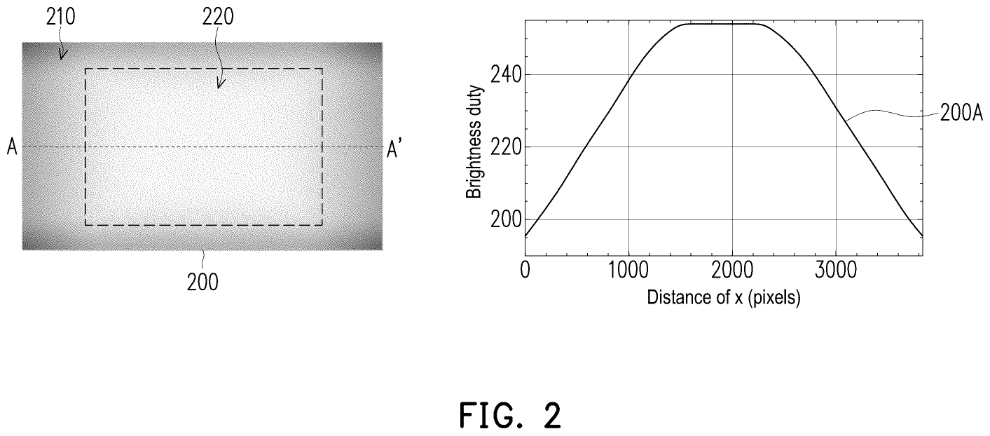

FIG. 1 is a block diagram illustrating an electronic device according to an embodiment of the invention. FIG. 2 is a schematic diagram illustrating a duty distribution of FIG. 1 according to an embodiment of the invention. Referring to FIG. 1 and FIG. 2, the electronic device 100 includes a driver circuit 110 and a display panel 120. The driver circuit 110 is configurable to be coupled to the display panel 120. The driver circuit 110 is configured to drive the display panel 120 to display images. The display panel 120 may be a self-illuminated display panel, e.g. an organic light-emitting diode (OLED) panel, but the invention is not limited thereto.

The driver circuit 110 includes an image processing circuit 112. The image processing circuit 112 is configured to receive and analyze an input image D_IN and adjust a brightness of the input image D_IN to generate an output image D_OUT according to at least one duty distribution 200. The duty distribution is configured to adjust the brightness of the input image D_IN. In FIG. 2, the duty curve 200A is a brightness distribution along the line AA′. The pixel line of the display panel 120 corresponding to the line AA′ is driven by the duty curve 200A and substantially has the same brightness distribution as the line AA′.

In the present embodiment, the duty distribution 200 includes a first area distribution 210 and a second area distribution 220, and a brightness of the first area distribution 210 is different from a brightness of the second area distribution 220. For example, an average brightness of the first area distribution 210 is smaller an average brightness distribution of the second area distribution 220. Therefore, a brightness of a first area of the input image D_IN corresponding to the first distribution 210 can be adjusted to be different from a brightness of the second area of the input image D_IN corresponding to the second distribution 220. That is to say, the driver circuit 110 may drive the first area and the second area with different brightness adjustment, so that the image quality of the main visual area, e.g. the second area, can be maintained, wherein the second area may be the center area, and the first area may be the outer area.

The image processing circuit 112 may determine the duty distribution 200 according to an analysis result of the input image D_IN. For example, the image processing circuit 112 analyzes image complexity, frame change or brightness distribution of the input image D_IN, and thus the analysis result includes at least one of the image complexity, the frame change and the brightness distribution of the input image D_IN.

Regarding hardware structures of the components in the embodiment of FIG. 2, the image processing circuit 112 may be a processor having computational capability. Alternatively, the image processing circuit 112 may be designed through hardware description languages (HDL) or any other design methods for digital circuits familiar to people skilled in the art and may be hardware circuits implemented through a field programmable gate array (FPGA), a complex programmable logic device (CPLD), or an application-specific integrated circuit (ASIC). In addition, enough teaching, suggestion, and implementation illustration for hardware structures of the image processing circuit 112 can be obtained with reference to common knowledge in the related art.

In the present embodiment, the electronic device 100 may be an electronic device having a display function, a touch sensing function and/or a fingerprint sensing function. In an embodiment, the electronic device 100 may be, but not limited to, a smartphone, a non-smart phone, a wearable electronic device, a tablet computer, a personal digital assistant, a notebook and other portable electronic devices that could operate independently and have the display function, the touch sensing function and/or the fingerprint sensing function. In an embodiment, the electronic device 100 may be, but not limited to, a portable or un-portable electronic device in a vehicle intelligent system. In an embodiment, the electronic device 100 may be, but not limited to, intelligent home appliances such as, a television, a computer, a refrigerator, a washing machine, a telephone, an induction cooker, a table lamp and so on.

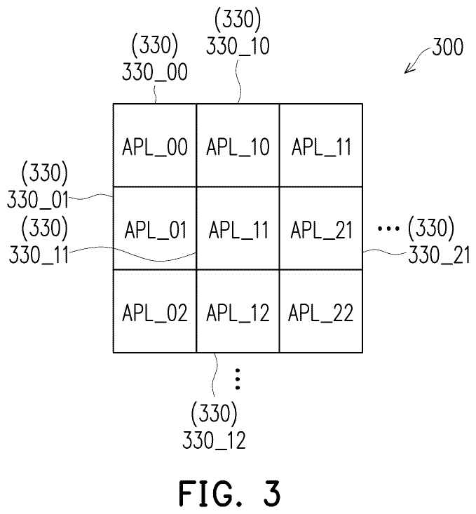

FIG. 3 is a schematic diagram illustrating average pixel levels of pixel block of an input image according to an embodiment of the invention. Referring to FIG. 1 and FIG. 3, a complexity calculation is described in the present embodiment. The image processing circuit 110 analyzes the image complexity of the input image 300 in a manner of block base.

To be specific, the input image 300 is divided into a plurality of pixel blocks 330, and each of pixel blocks 330 includes a plurality of pixels and has an average pixel level (APL). For example, the pixel block 330_00 has the average pixel level APL_00, and the pixel block 330_10 has the average pixel level APL_10. Average pixel levels of other pixel blocks 330 are marked in FIG. 3. For clarity and conciseness, only nine pixel blocks are shown in FIG. 3, but the number of the pixel blocks does not intend to limit the invention. In an embodiment, the average pixel levels may be average brightness or average gray value of pixel blocks. The average pixel levels of pixel blocks 330 are used to estimate the image complexity of the input image 300.

Taking the pixel block 330_11 for example, the image processing circuit 112 may calculate a pixel value difference of a target pixel block 330_11 and a neighboring pixel block to determine the image complexity of the input image 300, and the target pixel block 330_11 and the neighboring pixel block are two neighboring pixel blocks. The neighboring pixel block may be selected from one of pixel blocks 330_10, 330_12, 330_01 and 330_21 that are located at the top, bottom, left and right sides of the target pixel block 330_11. In an embodiment, the neighboring pixel block may also be selected from one of pixel blocks 330_00, 330_11, 330_02 and 330_22 that are located in the diagonal direction of the target pixel block 330_11. In addition, the pixel value difference is a difference of the average pixel levels of the target pixel block 330_11 and the neighboring pixel block in the present embodiment.

When an absolute value of the pixel value difference is larger than a threshold value, the image processing circuit 112 adds one to a count value of the target pixel block 330_11, and the count value indicates the image complexity of the input image 300. A maximum value of the count value of the target pixel block 330_11 is eight, and the threshold value may be set as a percentage value of the pixel value of the target pixel block 330_11 or an absolute value. The count values of the other pixel blocks can be calculated in a similar manner. The total count value of all pixel blocks 330 are used to estimate the image complexity of the input image 300. The larger the total count value, the more complex the input image 300.

In the present embodiment, the average pixel levels of pixel blocks 330 are used to estimate the image complexity of the input image 300, but the invention is not limited thereto. In an embodiment, maximum pixel levels or other statistic parameters of pixel blocks 330 can also be used to estimate the image complexity of the input image 300. In addition, in the present embodiment, the image processing circuit 112 analyzes the image complexity of the input image 300 in the manner of block base, but the invention is not limited thereto. In an embodiment, the image processing circuit 112 may analyze the image complexity of the input image 300 in a manner of pixel base. That is, pixel values of each pixel of the input image 300 are used to estimate the image complexity of the input image 300. The image processing circuit 112 calculates the pixel value difference of the target pixel and the neighboring pixel of the input image to determine the image complexity, and the target pixel and the neighboring pixel are two neighboring pixels.

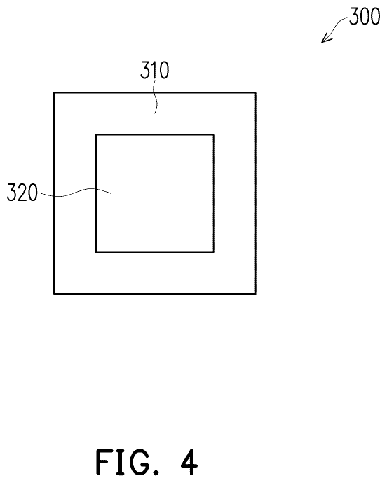

FIG. 4 is a schematic diagram illustrating an input image according to an embodiment of the invention. Referring to FIG. 4, the input image 400 includes a first area 410 and a second area 420, and the first area 410 surrounds the second area 420. The first area 410 may be the outer area surrounding the center area, and the second area 420 may be the center area and serve as the main visual area to show main image content.

The image processing circuit 112 can analyze the image complexity of the first area 410 and the second area 420 in the manner as illustrated in FIG. 3. The analysis result may indicate that the first area 410 is more complex than the second area 420. Next, the image processing circuit 112 determines the duty distribution for adjusting the brightness of the input image 400 according to the analysis result. The duty distribution may be set as the duty distribution 200 shown in FIG. 2. Therefore, the brightness of the first area 410 is adjusted to be different from the brightness of the second area 420.

For image complexity case, when the first area 410 is more complex, the brightness of the first area 410 is adjusted to be lower according to the duty distribution 200. Since the first area 410 is more complex, even if the brightness is adjusted to a lower level, it will not be easily noticed by the user, which not only reduces the power consumption but also maintains the display quality.

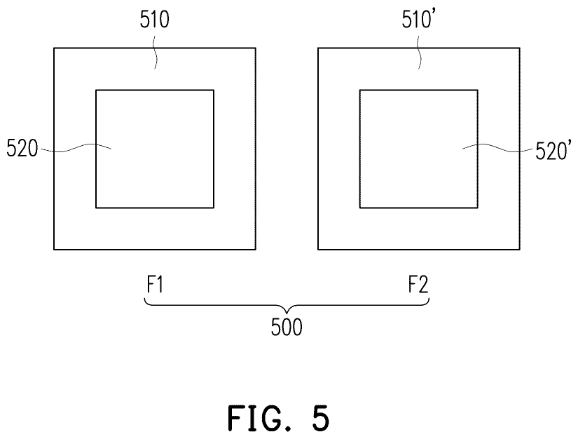

FIG. 5 is a schematic diagram illustrating an input image according to an embodiment of the invention. Referring to FIG. 1 and FIG. 5, in the present embodiment, the image processing circuit 110 may detect whether the input image 510 is static or dynamic by analyzing frame change of the input image 510.

To be specific, the input image 500 includes a previous frame F1 and a current frame F2. The previous frame F1 includes a first area 510 and a second area 520, and the first area 510 surrounds the second area 520. Similarly, the current frame F2 includes a first area 510′ and a second area 520′, and the first area 510′ also surrounds the second area 520′. The image processing circuit 112 calculates a pixel value difference of the first area 510 of the previous frame F1 and the first area 510′ of the current frame F2 to determine whether the first area 510′ is static. The pixel value difference of the first areas 510 and 510′ may be a difference of an average pixel level of the first area 510 and an average pixel level of the first area 510′, but the invention is not limited thereto.

When the analysis result is that the pixel value difference of the first areas 510 and 510′ is lower than a threshold value, it indicates that the first area 510′ has not changed much over time. Next, the image processing circuit 112 determines the duty distribution for adjusting the brightness of the input image 500 according to the analysis result. The duty distribution may be set as the duty distribution 200 shown in FIG. 2. Therefore, the brightness of the first area 510′ is adjusted to be different from the brightness of the second area 520′.

For frame change in a case that the area is static, when the first area 510′ is static, the brightness of the first area 510′ is adjusted to be lower. Since the first area 510′ is static, even if the brightness is adjusted to a lower level, it will not be easily noticed by the user, which not only reduces the power consumption but also maintains the display quality.

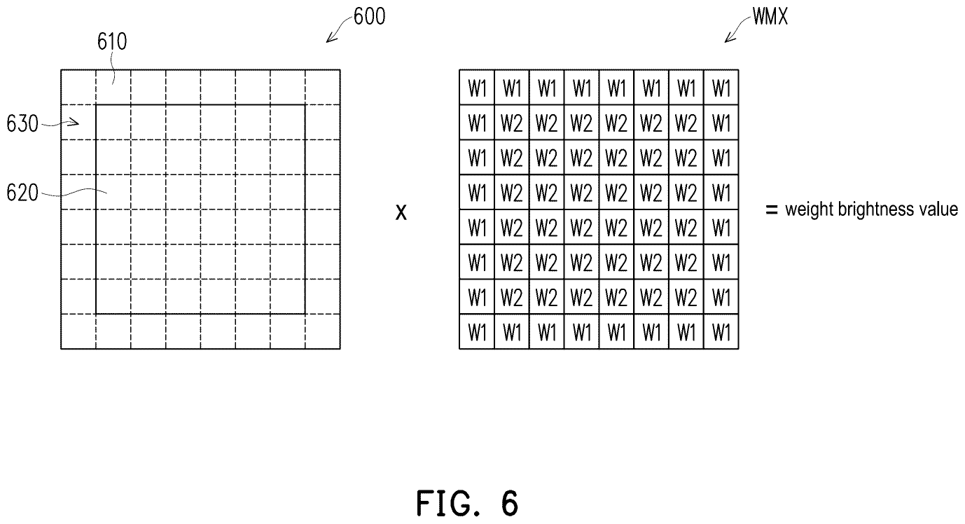

FIG. 6 is a schematic diagram illustrating an input image and a weight matrix according to an embodiment of the invention. Referring to FIG. 1 and FIG. 6, in the present embodiment, the image processing circuit 110 may calculates a weight brightness value of the input image 600 according to a weight matrix WMX to estimate its brightness distribution.

To be specific, the input image 600 includes a first area 610 and a second area 620, and the first area 610 surrounds the second area 620. The input image 600 is divided into a plurality of pixel blocks 630. The size and the number of the pixel blocks 630 are adjustable. The weight matrix WMX is set up to estimate the brightness distribution of the input image 600.

For example, the weight matrix WMX includes a plurality of first weight values W1 and second weight values W2. The first weight values W1 is corresponding to the first area 610 of the input image 600, and the second weight values W2 is corresponding to the second area 620 of the input image 600. To further estimate the brightness of the first area 610, the first weight values W1 are set to be larger than second weight values W2. The image processing circuit 112 calculates a weight sum of pixel values of the first area 610 and pixel values of the second area 620 to obtain the weight brightness value of the input image 600. The pixel values of the first areas 610 and the second area 620 may be average pixel levels of the first areas 610 and the second area 620, but the invention is not limited thereto.

Since the first weight values W1 are larger than second weight values W2, the pixel values of the first area 610 dominate in the weight brightness value. The analysis result, i.e. the weight brightness value, mainly shows the brightness of the first area 610. The image processing circuit 110 can estimate the brightness of the first area 610 by calculating the weight brightness value, i.e. the weight sum, according to the weight matrix WMX. When the analysis result is that the weight brightness value is larger than a threshold value, it indicates that the first area 610 is relatively bright. Next, the image processing circuit 112 determines the duty distribution for adjusting the brightness of the input image 600 according to the analysis result. The duty distribution may be set as the duty distribution 200 shown in FIG. 2. Therefore, the brightness of the first area 610 is adjusted to be different from the brightness of the second area 620.

For brightness distribution, when the first area 610 is brighter, the brightness of the first area 610 is adjusted to be lower. In the present embodiment, the brightness distribution of the input image 600 is analyzed and given a weight calculation. When the weight brightness value is lower, it indicates the first area 610 is dark, a less brightness reduction is given to avoid missing image details and other side effects. On the contrary, when the weight brightness value is larger, it indicates the first area 610 is brighter, a more brightness reduction is given.

In the embodiments of FIG. 2 to FIG. 6, the duty distribution 200 and the input images 400, 500 and 600 divided into two areas are taken for example, but the invention is not limited thereto. In an embodiment, the input image may be divided into more than two areas, and the image processing circuit 112 may select one duty distribution from a plurality of duty distributions according to the analysis result of the input image, and adjusts the brightness of the input image according to the selected duty distribution.

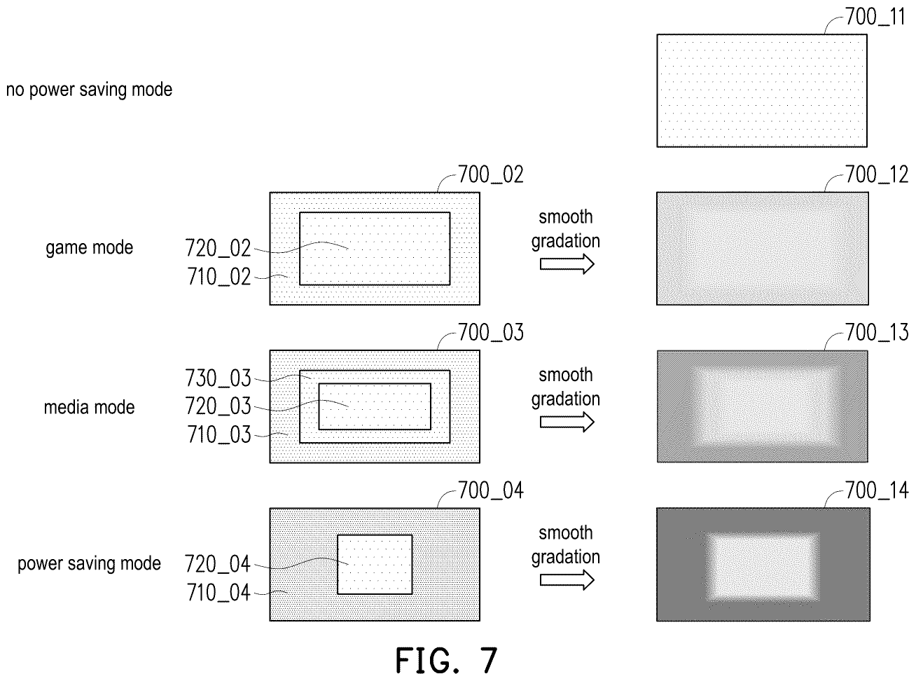

FIG. 7 is a schematic diagram illustrating different scenario modes and corresponding duty distributions according to an embodiment of the invention. Referring to FIG. 7, a plurality of duty distributions 700_11, 700_12, 700_13 and 700_14 corresponding different scenario modes are illustrated in FIG. 7. The scenario modes include a no power saving mode, a game mode, a media mode and a power saving mode. Only four scenario modes are shown in FIG. 7, but the type and the number of the scenario modes does not intend to limit the invention.

The duty distributions 700_11 is corresponding to the no power saving mode. The brightness of the input image is not adjusted according to the duty distributions 700_11 and maintained as 100% luminance.

The duty distributions 700_12 is corresponding to the game mode. The brightness of the input image is adjusted according to the duty distributions 700_12, and the center area is adjusted to be brighter than the outer area. The duty distributions 700_12 is obtained from the duty distribution 700_02 by a smooth gradation. The duty distributions 700_02 includes a first area distribution 710_02 and a second area distribution 720_02. The first area distribution 710_02 is set as 80% luminance and corresponding to the outer area of the input image. The second area distribution 720_02 is set as 100% luminance and corresponding to the center area of the input image. An average brightness of the first area distribution 710_02 is smaller than an average brightness distribution of the second area distribution 720_02.

The duty distributions 700_13 is corresponding to the media mode. The brightness of the input image is adjusted according to the duty distributions 700_13. The duty distributions 700_13 is obtained from the duty distribution 700_03 by the smooth gradation. The duty distributions 700_03 includes a first area distribution 710_03, a second area distribution 720_03, and a third area distribution 730_03. The first area distribution 710_03 is set as 60% luminance and corresponding to the first outer area of the input image. The second area distribution 720_03 is set as 100% luminance and corresponding to the center area of the input image. The third area distribution 730_03 is set as 80% luminance and corresponding to the second outer area of the input image. The second outer area surrounds the center area, and the first outer area surrounds the second outer area. An average brightness of the first area distribution 710_03 is smaller than an average brightness distribution of the third area distribution 730_03. The average brightness of the third area distribution 730_03 is smaller than an average brightness distribution of the second area distribution 720_03.

The duty distributions 700_14 is corresponding to the power saving mode. The brightness of the input image is adjusted according to the duty distributions 700_14, and the center area is adjusted to be brighter than the outer area. The duty distributions 700_14 is obtained from the duty distribution 700_04 by the smooth gradation. The duty distributions 700_04 includes a first area distribution 710_04 and a second area distribution 720_04. The first area distribution 710_04 is set as 30% luminance to reduce the power consumption and corresponding to the outer area of the input image. The second area distribution 720_04 is set as 100% luminance and corresponding to the center area of the input image. An average brightness of the first area distribution 710_04 is smaller than an average brightness distribution of the second area distribution 720_04.

The image processing circuit 112 may select one duty distribution from the duty distributions 700_11, 700_12, 700_13 and 700_14 according to the analysis result of the input image, and adjusts the brightness of the input image according to the selected duty distribution 700_11, 700_12, 700_13 or 700_14.

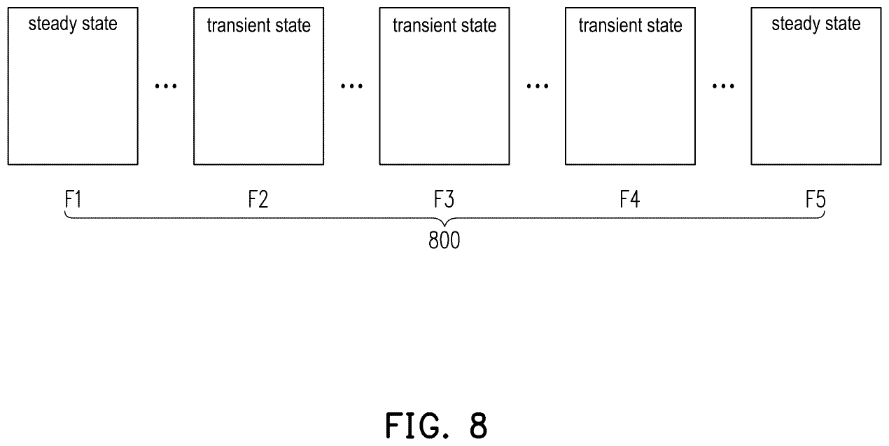

FIG. 8 is a schematic diagram illustrating a brightness adjustment of an input image according to an embodiment of the invention. Referring to FIG. 7 and FIG. 8, the input image 800 includes a plurality of frames F1 to F5. The frames F1 and F5 are located at a steady state, and the frames F2, F3 and F4 are located at a transient state. A brightness of the original frame F1 will be adjusted to a brightness of the target frame F5.

To be specific, the image processing circuit 112 analyzes the input image 800 and determines to adjust the input image 800 from the no power saving mode to the power saving mode. The image processing circuit 112 selects the duty distribution 700_14 according to the analysis result, and adjusts the brightness of the input image 800 according to the selected duty distribution 700_14. The image processing circuit 112 gradually adjusts the brightness of the input image 800 according to the duty distributions 700_11 and 700_14 and interpolation of the duty distributions 700_11 and 700_14.

For example, the brightness distribution of the original frame F1 is the same as the duty distribution 700_11, and the image processing circuit 112 aims to adjust the brightness distribution of the target frame F5 to be the same as the duty distribution 700_14. The image processing circuit 112 calculates a first interpolation of the duty distributions 700_11 and 700_14. The image processing circuit 112 calculates a second interpolation of the duty distributions 700_11 and the first interpolation. The image processing circuit 112 calculates a third interpolation of the duty distributions 700_14 and the first interpolation. The image processing circuit 112 respectively adjusts the brightness of the frames F2, F3, F4 and F5 according to the second interpolation, the first interpolation, the third interpolation and the duty distribution 700_14, so that the brightness of the original frame F1 can be gradually adjusted to a brightness of the target frame F5.

As a result, the brightness of the input image 800 can be adjusted to generate an output image according to the duty distributions 700_11 and 700_14 and interpolation of the duty distributions 700_11 and 700_14. Since the brightness of the input image 800 is gradually adjusted, it will not be easily noticed by the user, which not only reduces the power consumption but also maintains the display quality.

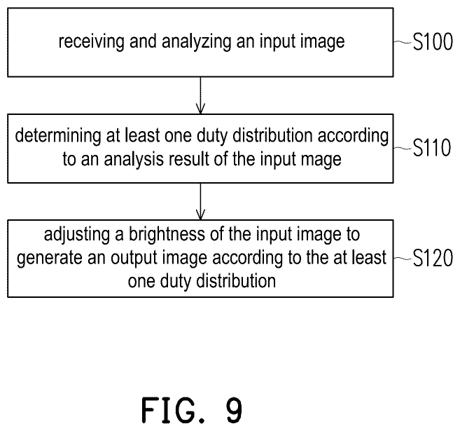

FIG. 9 is a flowchart illustrating a method for driving a display panel according to an embodiment of the invention. Referring to FIG. 1, FIG. 2 and FIG. 9, the method for driving the display panel is at least adapted to the electronic device 100 depicted in FIG. 1, but the invention is not limited thereto.

In step S100, the image processing circuit 112 receives and analyzes an input image D_IN. In step S110, the image processing circuit 112 determines at least one duty distribution 200 according to an analysis result of the input mage D_IN. In step S120, the image processing circuit 112 adjusts a brightness of the input image D_IN to generate an output image D_OUT according to the at least one duty distribution 200.

The method for driving the display panel described in the embodiment of the invention is sufficiently taught, suggested, and embodied in the embodiments illustrated in FIG. 1 to FIG. 8, and therefore no further description is provided herein.

In summary, the disclosure aims to reduce the power consumption of the display panel while maintaining good image quality by reducing the amount of light emitted. Unlike a case that reduces the brightness of the whole image, the driver circuit may drive the center area and the outer area with different brightness adjustment, so that the image quality of the main visual area, e.g. the center area, can be maintained.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A driver circuit, configured to drive a display panel, the driver circuit comprising:
an image processing circuit, configured to receive and analyze an input image and adjust a brightness of the input image to generate an output image according to a plurality of duty distributions corresponding to different scenario modes,
wherein the image processing circuit selects one of the plurality of duty distributions according to an analysis result of the input image, the input image comprises a first area and a second area, and a brightness of the first area is adjusted to be different from a brightness of the second area, and
wherein the image processing circuit adjusts the brightness of the input image according to the selected duty distribution.

2. The driver circuit of claim 1, wherein the analysis result comprises at least one of image complexity, frame change and brightness distribution of the input image.

3. The driver circuit of claim 2, wherein when the first area is more complex, the brightness of the first area is adjusted to be lower.

4. The driver circuit of claim 2, wherein the image processing circuit calculates a pixel value difference of a target pixel and a neighboring pixel of the input image to determine the image complexity, and the target pixel and the neighboring pixel are two neighboring pixels.

5. The driver circuit of claim 4, wherein when the pixel value difference is larger than a threshold value, the image processing circuit adds one to a count value of the target pixel, and the count value indicates the image complexity of the input image.

6. The driver circuit of claim 4, wherein the image processing circuit analyzes the image complexity of the input image in a manner of block base or pixel base.

7. The driver circuit of claim 2, wherein when the first area is more static, the brightness of the first area is adjusted to be lower.

8. The driver circuit of claim 7, wherein the input image comprises a previous frame and a current frame, and the image processing circuit calculates a pixel value difference of the first area of the previous frame and the first area of the current frame to determine whether the first area is static.

9. The driver circuit of claim 2, wherein when the first area is brighter, the brightness of the first area is adjusted to be lower.

10. The driver circuit of claim 2, wherein the image processing circuit calculates a weight brightness value of the input image according to a weight matrix, wherein the weight matrix comprises a plurality of first weight values and second weight values, and the first weight values are larger than second weight values.

11. The driver circuit of claim 10, wherein the first weight values are corresponding to the first area, the second weight values are corresponding to the second area, and the image processing circuit calculates a weight sum of pixel values of the first area and pixel values of the second area to obtain the weight brightness value of the input image.

12. The driver circuit of claim 1, wherein the first area surrounds the second area.

13. The driver circuit of claim 1, wherein the image processing circuit gradually adjusts the brightness of the input image according to the duty distributions and interpolation of the duty distributions.

14. (canceled)

15. A method for driving a display panel, the method comprising:
receiving and analyzing an input image;
determining a plurality of duty distributions corresponding to different scenario modes;
selecting one duty distribution from the plurality of duty distributions according to an analysis result of the input image; and
adjusting a brightness of the input image to generate an output image according to the selected duty distribution,
wherein the input image comprises a first area and a second area, and a brightness of the first area is adjusted to be different from a brightness of the second area.

16. The method of claim 15, wherein the analysis result comprises at least one of image complexity, frame change and brightness distribution of the input image.

17. The method of claim 15, wherein an image processing circuit analyzes the image in a manner of block base or pixel base.

18. The method of claim 15, wherein the first area surrounds the second area.

19. (canceled)

20. (canceled)
